(19) United States
(12) Patent Application Publication
(10) Pub. No.: US 2014/0144933 A1
(43) Pub. Date: May 29, 2014

(54) HOT MELT ADHESIVE SYSTEMS, ADHESIVE DEGRADATION DETECTION DEVICES, AND RELATED METHODS

(71) Applicant: NORDSON CORPORATION, Westlake, OH (US)

(72) Inventors: Peter W. Estelle, Norcross, GA (US); Mark A. Gould, Gainesville, GA (US); Laurence B. Saidman, Duluth, GA (US)

(73) Assignee: NORDSON CORPORATION, Westlake, OH (US)

(21) Appl. No.: 13/795,365

(22) Filed: Mar. 12, 2013

Related U.S. Application Data
(60) Provisional application No. 61/731,118, filed on Nov. 29, 2012.

(51) Int. Cl. B05C 9/14

(52) U.S. Cl. CPC B05C 9/14
USPC 222/23; 137/15.05; 356/436; 165/287

(57) ABSTRACT

A hot melt adhesive system includes an adhesive supply and an adhesive supply heater associated with the adhesive supply for melting hot melt adhesive material into a liquid hot melt adhesive. An adhesive dispenser is fluidly coupled with the adhesive supply and includes an outlet for dispensing the liquid hot melt adhesive. A fluid passage extends from the adhesive supply to the outlet of the adhesive dispenser; and an adhesive degradation detection device is operatively coupled to the fluid passage. The adhesive degradation detection device includes an energy source for emitting energy into the liquid hot melt adhesive in the fluid passage. The adhesive degradation detection device further includes a detector configured for detecting attenuated energy that emerges from the liquid hot melt adhesive. A controller operatively coupled to the adhesive degradation detection device can determine a degradation condition of the liquid hot melt adhesive.

### CROSS-REFERENCE TO RELATED APPLICATION

This application claims the priority of Application Ser. No. 61/731,118 filed Nov. 29, 2012 (pending), the disclosure of which is hereby incorporated by reference herein.

### TECHNICAL FIELD

The present invention generally relates to hot melt adhesive dispensing equipment.

### BACKGROUND

Hot melt adhesive systems have many applications in diverse fields, such as in a variety of manufacturing and packaging applications. For example, thermoplastic hot melt adhesives are used for carton sealing, case sealing, tray forming, pallet stabilization, nonwovens applications including diaper manufacturing, and many other applications. The hot melt adhesive is heated and melted, and ultimately applied to an object such as a work piece, substrate or product by a dispenser suitable to the application. Generally, hot melt adhesive dispensing systems can include a melter that includes a tank and one or more heating devices for melting solid or semi-solid adhesive. The melted adhesive is pumped to the dispenser via other components such as a manifold and heated hoses. Heaters are typically thermally connected to several components of a hot melt adhesive system, including the adhesive supply (such as a tank, grid, reservoir), manifold, hoses, and dispenser. The heaters maintain the liquid hot melt adhesive at proper adhesive viscosity and temperature for the application.

Liquid hot melt adhesive is susceptible to degradation under operational conditions in some hot melt adhesive systems. For example, liquid hot melt adhesive may degrade over time even if it is not heated above the proper application temperature. As liquid hot melt adhesive degrades, adhesive characteristics may likewise degrade.

### SUMMARY OF THE INVENTION

Embodiments of the present invention are directed to hot melt adhesive systems having adhesive degradation detection devices, adhesive degradation detection devices for use with hot melt adhesive systems, and related methods.

According to one embodiment of the invention, a hot melt adhesive system includes an adhesive supply for receiving unmelted hot melt adhesive material and an adhesive supply heater associated with the adhesive supply for melting the unmelted hot melt adhesive material into a liquid hot melt adhesive material. The hot melt adhesive system further includes at least one adhesive dispenser fluidly coupled with the adhesive supply and including an outlet for dispensing the liquid hot melt adhesive, a fluid passage extending from the adhesive supply to the outlet of the adhesive dispenser; and an adhesive degradation detection device operatively coupled to the fluid passage. The adhesive degradation detection device includes an energy source configured for emitting energy into the liquid hot melt adhesive in the fluid passage. The energy becomes attenuated energy after emerging from the liquid hot melt adhesive. The adhesive degradation detection device further includes a detector configured for detecting the attenuated energy, and a controller operatively coupled to the adhesive degradation detection device. The controller is configured to determine an amount of attenuation of the energy to thereby determine a degradation condition of the liquid hot melt adhesive.

According to another embodiment of the invention, an adhesive degradation detection device is provided for use with a hot melt adhesive system configured for dispensing liquid hot melt adhesive. The adhesive degradation detection device includes a body having a fluid channel configured for communicating the liquid hot melt adhesive therethrough. The adhesive degradation detection device further includes an energy source coupled with the body and configured for emitting energy into the liquid hot melt adhesive in the fluid channel. The energy becomes attenuated energy after emerging from the liquid hot melt adhesive. The adhesive degradation detection device further includes a detector coupled with the body and configured for detecting the attenuated energy and for detecting a degradation condition of the liquid hot melt adhesive.

According to yet another embodiment of the invention, a method is provided for assessing the degradation of liquid hot melt adhesive in a hot melt adhesive system. The method includes directing energy into the liquid hot melt adhesive, and detecting energy that emerges from the liquid hot melt adhesive.

Various additional features and advantages of the invention will become more apparent to those of ordinary skill in the art upon review of the following detailed description of the illustrative embodiments taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a diagrammatic view in partial cross-section of a hot melt adhesive system that includes an adhesive degradation detection device according to the concepts of the present invention.

FIG. 2 is a diagrammatic view in cross-section of the adhesive degradation detection device shown in FIG. 1.

FIG. 3 is a diagrammatic view in cross-section depicting an alternative adhesive degradation detection device.

### DETAILED DESCRIPTION OF THE ILLUSTRATIVE EMBODIMENTS

Referring to the figures, features of the present invention are shown in the context of an exemplary hot melt adhesive system 10. The hot melt adhesive system 10 includes an adhesive degradation detection device 12 for assessing the condition of liquid hot melt adhesive in the system 10, as will be evident from the following description. The general features of the hot melt adhesive system 10 are first introduced, and then the adhesive degradation detection device 12 is described.

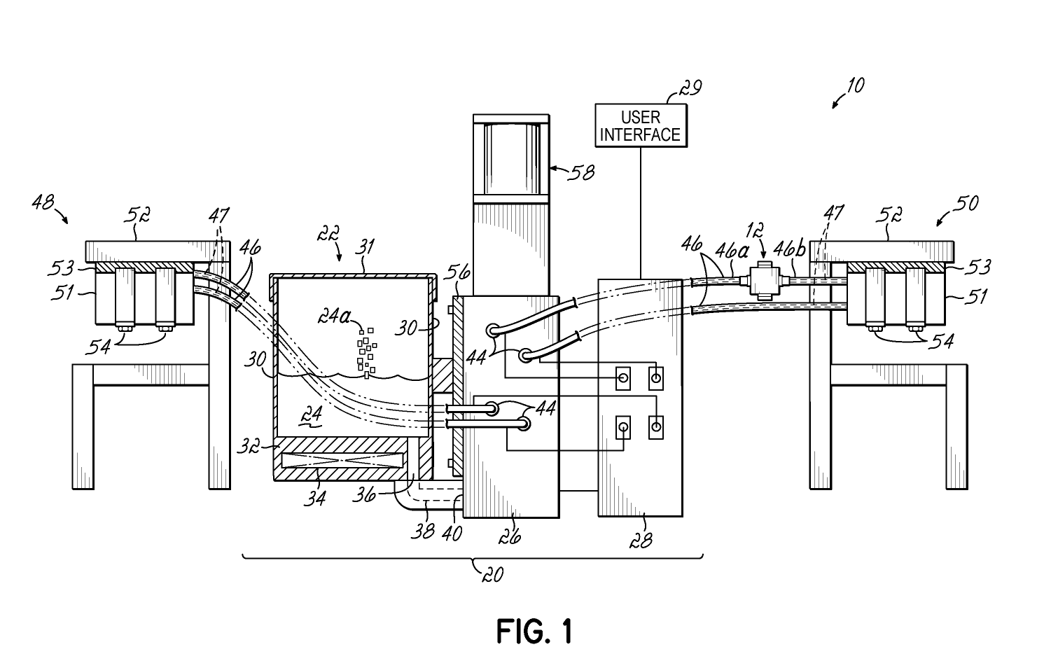

As best seen in FIG. 1, the hot melt adhesive system 10 includes a dispensing unit 20 that includes an adhesive supply 22 (a tank) for receiving and melting solid or semi-solid hot melt adhesive material 24a, a manifold 26 connected to the adhesive supply 22, a controller 28, and a user interface 29. Upon melting, the solid or semi-solid hot melt adhesive material 24a transforms into a liquid hot melt adhesive material 24. The adhesive supply 22 comprises side walls 30, a removable cover 31, and base 32 which includes one or more adhesive supply heaters 34 for melting and heating the hot melt adhesive material 24a and the liquid hot melt adhesive material 24 in the adhesive supply 22. The base 32 is integral with the adhesive supply 22 and contains one or more heaters 34 that are controlled by the controller 28. An outlet 36 proximate the base 32 is connected to a passage 38 which connects to an inlet 40 of the manifold 26.

As shown, a vertically-oriented piston pump 58 is connected to the manifold 26 for pumping liquid hot melt adhesive material 24 from the adhesive supply 22 and into the manifold 26 where it is split into separate flows. The manifold 26 includes a plurality of outlet ports 44 that are fitted with heated hoses 46 attached to one or more dispensers, which in the embodiment shown are adhesive guns 48, 50. The heated hoses 46 supply the liquid hot melt adhesive material 24 to the guns 48, 50. Each heated hose 46 is thermally connected to a hose heater 47. In addition, the manifold 26 includes a manifold heater 56 separate from the adhesive supply heater 34 and which can be independently controlled by the controller 28. Of course, it will be appreciated that a single heater could also be used for heating the adhesive supply 22 and the manifold 26.

The adhesive guns 48, 50 may include one or more adhesive dispensing modules 54 having outlets for dispensing/applying the liquid hot melt adhesive 24 to an object (not shown). The adhesive dispensing modules 54 are mounted to gun bodies 51 having gun heaters 53 and are supported on a frame 52. The hot melt adhesive system 10 shown in FIG. 1 includes two guns 48, 50, one located on each side of the dispensing unit 20, although different numbers of guns, dispensing modules, and other dispenser configurations may also be used.

The controller 28 includes the power supply and electronic controls for the hot melt adhesive system 10. The user interface 29 is connected with the controller 28 and can provide a user with information about, and control over, aspects of the hot melt adhesive system 10. For example, the user interface 29 can present information relating to the temperature of the heaters 34, 47, 53, and 56, hot melt adhesive flow rate, pump speed, and any other useful information. The user interface 29 can also include controls for adjusting the hot melt adhesive system 10, such as, for example, adjusting the temperature of the heaters 34, 47, 53, and 56, or the operation of the pump 58.

Thus, liquid hot melt adhesive 24 is contained in or flows through many of the components of the hot melt adhesive system 10, which components generally form a fluid passage 59 for communicating liquid hot melt adhesive 24 through the hot melt adhesive system 10. In particular, the solid or semi-solid hot melt adhesive material 24a is initially melted into liquid hot melt adhesive 24 in the adhesive supply 22. Liquid hot melt adhesive 24 flows from the adhesive supply 22 through the passage 38 to the manifold 26, and flows within the manifold 26. Liquid hot melt adhesive 24 flows out of the manifold 26 through the plurality of outlet ports 44 and into the heated hoses 46. Liquid hot melt adhesive 24 flows through the heated hoses 46 to the adhesive guns 48, 50. Liquid hot melt adhesive 24 is discharged from the adhesive guns 48, 50 through outlets of the adhesive dispensing modules 54. Thus, the fluid passage 59 is generally defined from the adhesive supply 22 to the outlets of the dispensing modules 54. More particularly, the fluid passage 59 includes all passageways or spaces in the adhesive supply 22 and the dispensing modules 54, and all passageways and spaces therebetween.

The adhesive degradation detection device 12 can be used to assess the degradation condition of the liquid hot melt adhesive 24 in the hot melt adhesive system 10, and can be operatively coupled to the fluid passage 59 at any location.

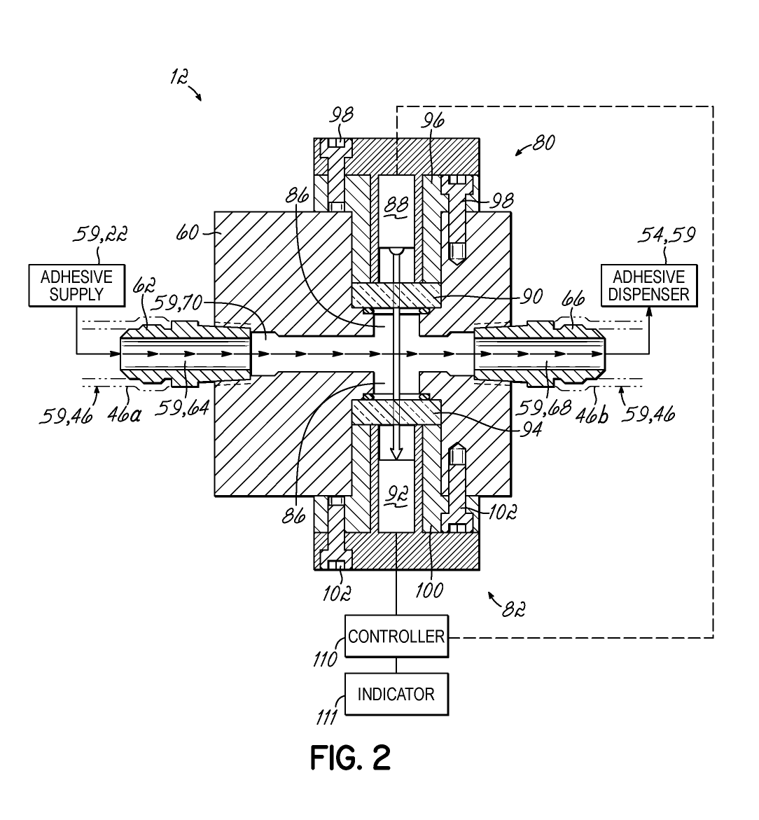

In the embodiment shown, and with reference to FIGS. 1 and 2, the adhesive degradation detection device 12 is operatively coupled to the fluid passage 59 part-way along one of the heated hoses 46 between the manifold 26 and the adhesive gun 50.

The adhesive degradation detection device 12 generally includes a body 60 that is configured to connect with the heated hose 46. To that end, an inlet 62 having an inlet passageway 64 is coupled with the body 60, and the inlet 62 is configured to couple with the portion 46a of the heated hose 46 between the manifold 26 and the adhesive degradation detection device 12.

In addition, an outlet 66 having an outlet passageway 68 is coupled with the body 60, and the outlet 66 is configured to couple with the portion 46b of the heated hose 46 between the adhesive degradation detection device 12 and the adhesive gun 50. The body 60 includes a fluid channel 70 that communicates with both the inlet passageway 64 and the outlet passageway 68 so that liquid hot melt adhesive 24 can flow through the adhesive degradation detection device 12. In particular, liquid hot melt adhesive 24 enters the adhesive degradation detection device 12 through the inlet passageway 64, flows from the inlet passageway 64 to the fluid channel 70, flows from the fluid channel 70 to the outlet passageway 68, and exits the adhesive degradation detection device 12 through the outlet passageway 68. Thereby, the inlet passageway 64, the fluid channel 70, and the outlet passageway 68 are part of the fluid passage 59.

The adhesive degradation detection device 12 also includes an energy emitting device 80 and a detector device 82. The energy emitting device 80 is configured to emit energy toward the detector device 82. An energy channel 86 is formed in the body 60, and as shown, is generally perpendicular to the direction of the fluid channel 70. The energy emitting device 80 includes an energy source 88 that is generally situated in the energy channel 86 and behind an emitter window 90, so that the emitter window 90 is between the energy source 88 and the fluid channel 70. The detector device 82 includes a detector 92 that is also generally situated in the energy channel 86 and is behind a detector window 94, so that the detector window 94 is between the detector 92 and the fluid channel 70. In the embodiment shown, the energy source 88 and the detector 92 are located on opposite sides of the fluid channel 70.

The energy source 88 is coupled with a mounting block 96 that is attached to the body 60 by fasteners 98. In a similar manner, the detector 92 is coupled with a mounting block 100 that is attached to the body 60 by fasteners 102.

The energy source 88 is configured to emit energy, as indicated schematically by the arrow-headed line shown in FIG. 2. In particular, the energy source 88 emits energy that travels in the energy channel 86 and is directed at the fluid channel 70. The energy crosses the fluid channel 70 and is detected or sensed on the other side of the fluid channel 70 by the detector 92. In use, and when the fluid channel 70 contains liquid hot melt adhesive 24, the energy source 88 emits energy that goes through the liquid hot melt adhesive 24 before it reaches the detector 92.

The energy source 88 may be selected based upon a particular application. Generally, the energy source 88 is selected so that it produces energy that is attenuated, or absorbed so as to be diminished, in a determinable manner by the liquid hot melt adhesive 24 that passes through the adhesive degradation detection device 12. For example, the relationship between an amount of attenuation of energy by the liquid hot melt adhesive and the extent of adhesive degradation may be determined.

In particular, the extent of degradation of the liquid hot melt adhesive 24 may be dependent upon the amount of time it has been melted and the amount of heat it has received in the hot melt adhesive system 10. Generally, liquid hot melt adhesive 24 is more transparent when it is first melted than it is after it has been melted and heated extensively. Also, liquid hot melt adhesive 24 becomes generally less transparent as the amount of time it has been melted and the amount of heat it has received increases. As the liquid hot melt adhesive 24 becomes less transparent, the attenuation of the energy increases. Some liquid hot melt adhesives, for example, turn yellow and then brown as they degrade.

For example, liquid hot melt adhesive 24 that is just melted (not yet degraded) will attenuate energy to a lesser extent than liquid hot melt adhesive 24 that has been melted for a greater, yet intermediate, amount of time and that has absorbed a greater, yet intermediate amount of heat (partially degraded). Further, partially degraded liquid hot melt adhesive 24 will attenuate energy to a lesser extent than liquid hot melt adhesive 24 that has been melted for an even greater amount of time and that has absorbed an even greater amount of heat (nearly completely, or completely, degraded). Thus, attenuation of energy increases as the amount of time that the liquid hot melt adhesive 24 has been melted and the amount of heat it has absorbed increases.

The relationship between the amount of attenuation of energy and the degradation of the liquid hot melt adhesive 24 may also be dependent upon the characteristics of the energy, such as its wavelength(s). Generally, the amount of attenuation of energy and the degradation of the liquid hot melt adhesive 24 can be determined. For example, in some embodiments the liquid hot melt adhesive 24 tends to attenuate purple, blue, and green light, or light corresponding to wavelengths ranging from approximately 380 nm-570 nm, according to a determinable monotonic relationship.

In some embodiments, the energy source 88 includes an LED light source that produces energy having a specific wavelength. In some of these embodiments, the LED light source is chosen so as to produce energy having wavelengths shorter than about 550 nm. For example, LED light sources that produce purple light (about 405 nm) and blue light (about 470 nm) might be used. It has been observed that as liquid hot melt adhesive degrades and becomes increasingly yellow or brown, light having wavelengths generally corresponding with purple and blue light is absorbed. The energy created by the energy source 88 has characteristics, such as wavelength and intensity, which may be known or determined. In some embodiments, the energy source 88 is configured to provide energy on a continuous basis, and in other embodiments the energy source 88 is configured to provide energy on a pulsed, or intermittent, basis. The energy source 88 can provide energy as a beam of energy, for example.

The detector 92 may be selected so as to operate with the energy source 88. Generally, the detector 92 is selected so that it appropriately detects and measures the energy that is created by the energy source 88 and that passes through or emerges from the liquid hot melt adhesive 24 in the adhesive degradation detection device 12. Energy is attenuated by the liquid hot melt adhesive 24, and the energy that emerges from the liquid hot melt adhesive 24 is referred to as attenuated energy. In some embodiments, the detector 92 includes a photodiode which detects and measures the attenuated energy. In addition, the detector 92 can include other components for sensing, measuring, or processing the attenuated energy, such as signal amplifiers, filters, and the like.

A controller 110 is operatively coupled with the adhesive degradation detection device 12. The controller 110 is configured to determine an amount of attenuation of the energy. The controller 110 can be coupled with the energy source 88 and the detector 92, as appropriate. The controller 110 is further configured to determine a degradation condition of the liquid hot melt adhesive 24. For example, the controller 110 may determine a degradation condition based on an amount of attenuation. An indicator 111 is operatively coupled with the controller 110 and configured to present information relating to the degradation condition of the liquid hot melt adhesive 24. The indicator 111 can include a visual display, such as a screen or light indicator, a noise device, such as an alarm, or any other type of indicator, as may be appropriate. Further, the controller 110 may optionally be coupled with the controller 28, such as for communicating with the controller 28, as will be described further below.

The positional relationship between the energy source 88 and the detector 92 may be controlled and adjusted. For example, it is often appropriate to maintain a constant separation distance between the energy source 88 and the detector 92. This separation distance can be modified, such as by moving one or both of the energy source 88 and detector 92 with respect to the other. For example, in some embodiments, the distance between the energy source 88 and the detector 92 is approximately 2 inches. In addition, it is often appropriate for the energy created by the energy source 88 to pass through a constant distance of the liquid hot melt adhesive material 24. In the embodiment shown, the distance of the liquid hot melt adhesive material 24 that the energy passes through is defined by the distance between the emitter window 90 and the detector window 94. The distance of the liquid hot melt adhesive 24 that the energy passes through can be adjusted, such as by changing the relative spacing of the emitter window 90 and the detector window 94. For example, in some embodiments, the distance between the emitter window 90 and the detector window 94 is approximately ⅞ of an inch.

Further, while the embodiment shown includes the energy source 88 and the detector 92 located on opposite sides of the fluid channel 70 with the energy channel 86 being generally perpendicular with the fluid channel 70, other configurations are possible. For example, the energy source 88 and the detector 92 could be on the same side of the fluid channel 70, with the energy being reflected back toward the detector 92 after it passes through some or all of the liquid hot melt adhesive material 24 in the fluid channel 70. Alternatively, the energy source 88 and the detector 92 can be positioned so that the energy is directed at a non-perpendicular angle with respect to the fluid channel 70, whereby the energy travels through a greater distance of the liquid hot melt adhesive material 24 than it would if the energy were directed at a perpendicular angle.

The adhesive degradation detection device 12 can be used to assess the degradation condition of the liquid hot melt adhesive 24 in the system 10. In particular, the energy source 88 emits energy (having known characteristics) that travels through a known and fixed distance of the liquid hot melt adhesive 24. The energy is attenuated by the liquid hot melt adhesive 24, so that energy that emerges from the liquid hot melt adhesive 24 is attenuated energy. The amount of attenuation of energy will be according to a determinable relationship for the energy source 88. The attenuated energy emerges from the liquid hot melt adhesive 24 and is detected and measured by the detector 92. The amount of attenuation of energy by the liquid hot melt adhesive 24 can then be determined, such as by the controller 110.

The degradation condition of the liquid hot melt adhesive 24 can be determined, such as by the controller 110. For example, the determination of the degradation condition can be based on the amount of attenuation of the energy by the liquid hot melt adhesive 24. The adhesive degradation detection device 12 can be used, for example, to determine an amount of attenuation of energy before the liquid hot melt adhesive 24 has degraded to thereby establish a baseline measurement or reading. Subsequent determinations of the amount of attenuation of energy can then be compared with the baseline measurement to provide a metric for determining the degradation condition of the liquid hot melt adhesive 24. Alternatively or additionally, the controller 110 can include stored attenuation values, such as attenuation values representative of the liquid hot melt adhesive 24 in a non-degraded condition. Measured determinations of the amount of attenuation of energy can be compared with the stored attenuation values for determining the degradation condition of the liquid hot melt adhesive 24.

Information about the degradation condition of the liquid hot melt adhesive 24 can be presented using the indicator 111. The information about the degradation condition of the liquid hot melt adhesive 24 can be considered by a user or the controller 110 and may be relevant to operation of the hot melt adhesive system 10. For example, if it is determined that the liquid hot melt adhesive 24 is completely degraded, or nearly completely degraded, a user might choose to purge or discard that liquid hot melt adhesive 24, or a portion thereof and add a new supply of unmelted solid or semi-solid hot melt adhesive material 24a to the adhesive supply 22 so as to provide liquid hot melt adhesive material 24 that is not yet degraded. For example, some or all of the degraded liquid hot melt adhesive 24 could be directed to a waste container. As a new supply of unmelted solid or semi-solid hot melt adhesive material 24a is melted into liquid hot melt adhesive material 24, that new supply can be mixed with some of the degraded liquid hot melt adhesive 24 to create a mixture of liquid hot melt adhesive 24. Further, a user could also choose to shut down the hot melt adhesive system 10 to cease dispensing liquid hot melt adhesive 24.

In addition, a user or the controller 110 can monitor the degradation condition of the liquid hot melt adhesive 24 and then control the temperature of any of the heaters 34, 47, 53, and 56 in response to changes in the degradation condition. For example, the controller 110 can communicate with the controller 28 in order that the temperature of any of the heaters 34, 47, 53, and 56 can be reduced to slow or prevent further degradation of the liquid hot melt adhesive 24. However, because the liquid hot melt adhesive 24 that is dispensed through the outlets of the adhesive dispensing modules 54 should be maintained at an appropriate application temperature, controlling the heaters 24, 47, 53, and 56 would have to be accomplished while still dispensing liquid hot melt adhesive 24 at the proper application temperature. Thus, after the temperature of the liquid hot melt adhesive 24 is reduced, it may have to be increased as part of a dispensing operation. Alternatively or additionally, the heaters 24, 47, 53, and 56 can be selectively controlled to maintain a reduced temperature in some areas of the hot melt adhesive system 10 while providing an appropriate application temperature for the liquid hot melt adhesive 24 that is dispensed through the outlets of the adhesive dispensing modules 54. Without being limited to any particular theory, it is believed that a minor reduction in the temperature of the liquid hot melt adhesive 24 (such as about 10-20° F.) can appreciably reduce the rate of degradation of the liquid hot melt adhesive 24. Moreover, such a minor reduction in temperature is easily reversed by heating, thereby making returning the liquid hot melt adhesive 24 to an appropriate temperature easily and quickly achieved.

The operation of the system 10 can also be adjusted based on the detection of the attenuated energy by the detector 92. For example, in response to the detector 92 detecting attenuated energy, an amount of liquid hot melt adhesive 24 can be purged from the system 10, or temperature values within the system 10 adjusted.

The adhesive degradation detection device 12 shown in FIGS. 1 and 2 is designed to be a non-permanent component of the hot melt adhesive system 10. For example, the adhesive degradation detection device 12 is designed so as to be removably coupled into the heated hose 46 extending between the manifold 26 and the adhesive gun 50. Thus, the adhesive degradation detection device 12 includes the inlet 62 and the outlet 66 which are configured to be coupled with a component of the hot melt adhesive system 10, such as the sections 46a, 46b of the heated hose 46 (as shown). The adhesive degradation detection device 12 can therefore be installed and removed in conjunction with a hot melt adhesive system, such as to perform process monitoring or diagnostics, as desired.

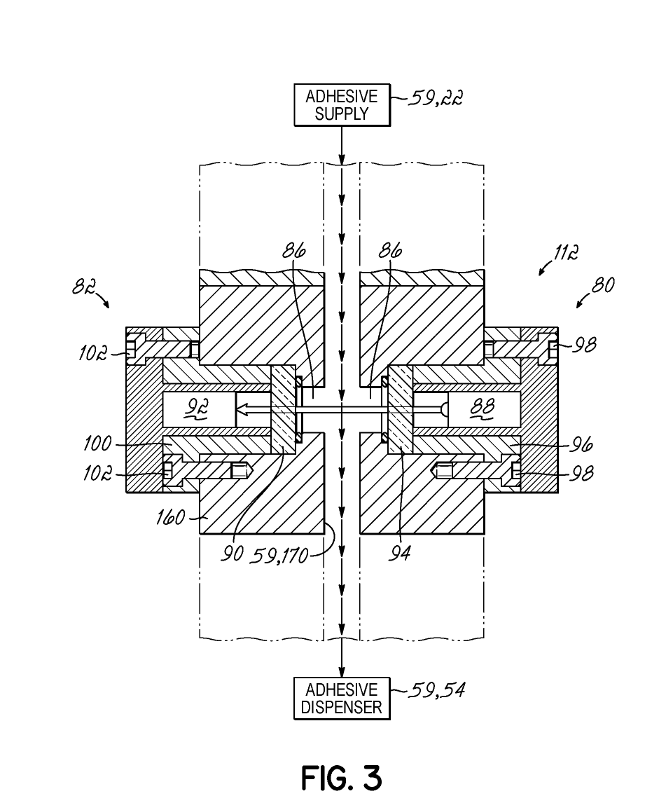

Alternatively, an adhesive degradation detection device can be permanently installed into a hot melt adhesive system. For example, and with reference to FIG. 3, an adhesive degradation detection device 112 is shown that is substantially similar to the adhesive degradation detection device 12, but that is designed to be permanently installed into the hot melt adhesive system 10. The adhesive degradation detection device 112 can be permanently installed in any of the components of the hot melt adhesive system 10, including for example, in the passageway 38, in the manifold 26, or in either of the adhesive guns 48, 50. The adhesive degradation detection device 112 includes a body 160 having a fluid channel 170 that is configured to communicate with fluid passageways of one or more adjacent components in the hot melt adhesive system 10, whereby the fluid channel 170 is part of the fluid passage 59. For example, it is contemplated that the fluid channel 170 could be generally the same size as adjacent fluid passageways (generally indicated by dashed lines), such as in the manifold 26, for example. The adhesive degradation detection device 112 can therefore be permanently installed with a hot melt adhesive system, such as to perform process monitoring or diagnostics, as desired, whether continuously or at another interval. Where the adhesive degradation detection device 112 is permanently installed in the hot melt adhesive system 10, the controller 28 and the user interface 29 can also be used for performing and presenting information relative to the operation of the adhesive degradation detection device 112. For example, the controller 28 can be used like the controller 110 described above to determine an amount of attenuation of the energy, and determine a degradation condition of the liquid hot melt adhesive 24. The user interface 29 can be used present information relating to the degradation condition of the liquid hot melt adhesive 24, and can include a visual display, such as a screen or light indicator, a noise device, such as an alarm, or any other type of indicator, as may be appropriate. Alternatively, the adhesive degradation detection device 112 can be associated with a controller and indicator other than the controller 28 and the user interface 29, such as controller like the controller 110 and an indicator like the indicator 111 described above.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept. What is claimed is:

1. A hot melt adhesive system comprising:
an adhesive supply for receiving unmelted hot melt adhesive material,
an adhesive supply heater associated with the adhesive supply for melting the unmelted hot melt adhesive material into a liquid hot melt adhesive material,
at least one adhesive dispenser fluidly coupled with the adhesive supply and including an outlet for dispensing the liquid hot melt adhesive,
a fluid passage extending from the adhesive supply to the outlet of the adhesive dispenser; and
an adhesive degradation detection device operatively coupled to the fluid passage, the adhesive degradation detection device comprising:
an energy source configured for emitting energy into the liquid hot melt adhesive in the fluid passage, the energy becoming attenuated energy after emerging from the liquid hot melt adhesive,
a detector configured for detecting the attenuated energy, and
a controller operatively coupled to the adhesive degradation detection device and configured to determine an amount of attenuation of the energy to thereby determine a degradation condition of the liquid hot melt adhesive.

2. The hot melt adhesive system of claim 1, the adhesive degradation detection device being removably coupled with a component of the hot melt adhesive system.

3. The hot melt adhesive system of claim 1, the adhesive degradation detection device being permanently coupled with a component of the hot melt adhesive system.

4. The hot melt adhesive system of claim 1, the energy source including an LED light source.

5. The hot melt adhesive system of claim 4, the LED light source configured to produce energy having wavelengths shorter than about 550 nm.

6. The hot melt adhesive system of claim 1, further comprising:
an indicator operatively coupled with the controller and configured to present the degradation condition of the liquid hot melt adhesive to a user.

7. The hot melt adhesive system of claim 1, the adhesive degradation detection device further comprising a body having a fluid channel and an energy channel extending generally perpendicular to the fluid channel, the energy source and the detector positioned in the energy channel.

8. The hot melt adhesive system of claim 7, the adhesive degradation detection device further including an emitter window between the energy source and the fluid channel and a detector window between the detector and the fluid channel.

9. The hot melt adhesive system of claim 1, the detector including a photodiode.

10. An adhesive degradation detection device for use with a hot melt adhesive system configured for dispensing liquid hot melt adhesive, comprising:
a body having a fluid channel configured for communicating the liquid hot melt adhesive therethrough,
an energy source coupled with the body and configured for emitting energy into the liquid hot melt adhesive in the fluid channel, the energy becoming attenuated energy after emerging from the liquid hot melt adhesive, and
a detector coupled with the body and configured for detecting the attenuated energy and for detecting a degradation condition of the liquid hot melt adhesive.

11. The adhesive degradation detection device of claim 10, the energy source including an LED light source.

12. The adhesive degradation detection device of claim 11, the LED light source configured to produce energy having wavelengths shorter than about 550 nm.

13. The adhesive degradation detection device of claim 10, the body further comprising an energy channel extending generally perpendicular to the fluid channel, the energy source and the detector positioned in the energy channel.

14. The adhesive degradation detection device of claim 10, further including an emitter window between the energy source and the fluid channel and a detector window between the detector and the fluid channel.

15. The adhesive degradation detection device of claim 10, the detector including a photodiode.

16. A method of assessing the degradation of liquid hot melt adhesive in a hot melt adhesive system, comprising:
directing energy into the liquid hot melt adhesive,
detecting energy that emerges from the liquid hot melt adhesive.

17. The method of claim 16, wherein directing energy into the liquid hot melt adhesive includes directing energy using an LED light source.

18. The method of claim 17, wherein directing energy using an LED light source includes generating energy having wavelengths shorter than about 550 nm.

19. The method of claim 16, wherein energy that emerges from the liquid hot melt adhesive is attenuated energy, and wherein detecting energy includes detecting attenuated energy.

20. The method of claim 19, wherein directing energy into the liquid hot melt adhesive includes directing energy through an emitter window before directing energy into the liquid hot melt adhesive, and
wherein detecting attenuated energy includes directing the attenuated energy through a detector window before detecting the attenuated energy.

21. The method of claim 16, further comprising:
directing liquid hot melt adhesive through a passageway of an adhesive degradation detection device, and
directing energy through the liquid hot melt adhesive in the passageway.

22. The method of claim 16, further comprising:
determining a degradation condition of the liquid hot melt adhesive.

23. The method of claim 22, wherein determining a degradation condition includes determining the amount of attenuation of the energy caused by the liquid hot melt adhesive.

24. The method of claim 22, further comprising:
presenting information relating to the degradation condition using an indicator.

25. The method of claim 22, further comprising:
reducing the temperature of the liquid hot melt adhesive in response to the degradation condition of the liquid hot melt adhesive.

26. The method of claim 25, wherein reducing the temperature of the liquid hot melt adhesive includes reducing the temperature of a heater of the hot melt adhesive system.

27. The method of claim 25, further comprising:
increasing the temperature of the liquid hot melt adhesive after reducing the temperature of the liquid hot melt adhesive.

28. The method of claim 22, further comprising:
purging a portion of the liquid hot melt adhesive in response to the degradation condition of the liquid hot melt adhesive.

29. The method of claim 28, wherein purging a portion of the liquid hot melt adhesive includes purging substantially all of the liquid hot melt adhesive.

30. The method of claim 28, further comprising:
creating a new supply of liquid hot melt adhesive by melting unmelted solid or semi-solid hot melt adhesive material.

31. The method of claim 30, further comprising:
mixing the new supply with the liquid hot melt adhesive.

32. The method of claim 16, further comprising:
reducing the temperature of the liquid hot melt adhesive in response to detecting energy.

33. The method of claim 16, further comprising:
purging a portion of the liquid hot melt adhesive in response to detecting energy.
